(19) United States
(12) Patent Application Publication
(10) Pub. No.: US 2009/0318230 A1
(43) Pub. Date: Dec. 24, 2009

(54) Game System, Server, Gaming Machine

(75) Inventor: Shinji TSUKABE, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/251,063

(22) Filed: Oct. 14, 2008

Related U.S. Application Data
(60) Provisional application No. 61/075,142, filed on Jun. 24, 2008.

(51) Int. Cl. A63F 13/00; A63F 9/24

(52) U.S. Cl. 463/40; 463/42

(57) ABSTRACT

A new gaming environment is provided. When the start button of a gaming machine is pressed, start information is sent to a server. When the server receives the start information, it is determined whether or not the winning probability of bonus is changed in the gaming machine which sends the start information. If it is determined that the winning probability of bonus is changed, a new winning probability of bonus is determined, and setting information including the new winning probability of bonus is sent to the gaming machine which sends the start information. When the gaming machine receives the setting information, the winning probability of bonus is renewed based on the setting information. It is determined whether or not bonus is won based on the renewed winning probability of bonus. If it is determined that the bonus is won, a predetermined number of gaming media is provided.

### CROSS-REFERENCE TO RELATED APPLICATIONS

This application is based upon and claims a priority from the U.S. Provisional Patent Application No. 61/075142 filed on Jun. 24, 2008, the entire contents thereof are incorporated herein by reference for all purposes.

### BACKGROUND

1. Field

One or more aspects of the invention relate to a game system, a server, a gaming machine in which a winning probability of a bonus in each gaming machine is determined based on the number of executed games of each of gaming machines.

2. Description of Related Art

There are slot machines in which bonus occurs in a predetermined condition to enhance an entertainment aspects. Also, a probability of occurrence of the bonus is controlled based on the bet number in some of the conventional slot machines. Also, to attract players, a game system, and a server, and a gaming machine which has new feature is anticipated.

### SUMMARY

In view of the foregoing, one or more aspects of the invention relate to a game system, a server, a gaming machine, a gaming method thereof, a computer readable medium having computer-executable instructions or the like in which a new gaming environment is provided.

A game system according to one or more aspects of the invention comprises gaming machines and a server connected to the gaming machines. The server obtains a number of executed games from one of the gaming machines, determines information related to a bonus in the one of the gaming machines based on the received number, and sends the determined information to the one of the gaming machines. The gaming machine determines whether or not the bonus is won based on the received information, provides a predetermined number of gaming medium when the bonus is won, and clears the number of the executed games.

Herewith, since the winning probability of bonus is determined based on the number of executed games in each of the gaming machines, the entertainment character may be enhanced and it may attract more players.

A server according to one or more aspects of the invention is connected to gaming machines. The server obtains a number of executed games from one of the gaming machines, determines information related to a bonus in the one of the gaming machines based on the received number, and sends the determined information to the one of the gaming machines.

Herewith, since the winning probability of bonus is determined based on the number of executed games in each of the gaming machines, the entertainment character may be enhanced and it may attract more players.

A gaming machine according to one or more aspects of the invention is connected to a server. The gaming machine increments a number of executed games each time the game being executed, sends the incremented number of executed games to the server, receives information related to a bonus, determines whether or not the bonus is won based on the received information, provides a predetermined number of gaming medium when the bonus is won, and clears the number of the executed games when the bonus is won.

Herewith, since the winning probability of bonus is determined based on the number of executed games in each of the gaming machines, the entertainment character may be enhanced and it may attract more players.

One or more of the above aspects of the invention is more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the disclosure and, together with the description, serve to explain the objects, advantages and principles of the disclosure.

FIG. 1 is a flowchart of a server base process in accordance with one or more aspects of the invention.

FIG. 2 is a schematic structure view of a game system in accordance with one or more aspects of the invention.

FIG. 3 is an external perspective view of the game system in accordance with one or more aspects of the invention.

FIG. 4 is an external perspective view of a slot machine in accordance with one or more aspects of the invention.

FIG. 5 is a block diagram schematically showing an internal constitution of the game system in accordance with one or more aspects of the invention.

FIG. 6 is a block diagram schematically showing an internal constitution of the slot machine in accordance with one or more aspects of the invention.

FIG. 7 is a block diagram schematically showing the internal constitution of the slot machine in accordance with one or more aspects of the invention.

FIG. 8 is a flowchart of a main control process in accordance with one or more aspects of the invention.

FIG. 9 is a flowchart of a first renewing process in accordance with one or more aspects of the invention.

FIG. 10 is a flowchart of a main game process in accordance with one or more aspects of the invention.

FIG. 11 is an explanatory view of a first probability table in accordance with one or more aspects of the invention.

FIG. 12 is a flowchart of a second renewing process in accordance with one or more aspects of the invention.

FIG. 13 is an explanatory view of a rank table in accordance with one or more aspects of the invention.

FIG. 14 is a flowchart of the main game process in accordance with one or more aspects of the invention.

FIG. 15 is a flowchart of the server base process in accordance with one or more aspects of the invention.

FIG. 16 is an explanatory view of the second probability table in accordance with one or more aspects of the invention.

FIG. 17 is an explanatory view of a server table in accordance with one or more aspects of the invention.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present invention.

It is noted that various connections are set forth between items in the following description. It is noted that these connections in general and, unless specified otherwise, may be direct or indirect and that this specification is not intended to be limiting in this respect.

A gaming machine according to one or more aspects of the invention is described in detail with reference to the drawings based on an embodiment embodying one or more aspects of the invention as a slot machine, a server, a game system. However, it is appreciated that one or more aspects of the present invention may be embodied in distributable (via CD and the like) or downloadable software games, console games, and the like. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU” and “processor” are inclusive by nature, including at least one of hardware, software, or firmware. These terms may include a side of a processing unit in a computer (for instance, in multiple core processing units), multiple cores, a functional processor (as running virtually on at least one of processor or server, which may be local or remote). Further, in network-based game systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

### First Embodiment

Hereinafter, a first embodiment embodying one or more aspects of the invention will be described with reference to the drawings. Also, winning probability of bonus may mean a probability of occurrence of the bonus.

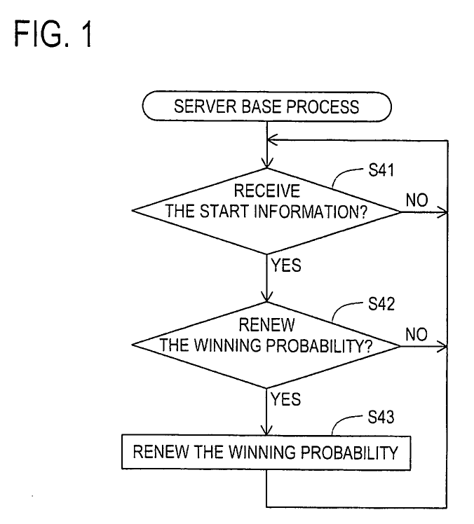

In the first embodiment, as shown in FIG. 1, in server 91, when the start information is received from any of the slot machines 1 (S41: YES), it is determined whether or not the winning probability of bonus is changed in the slot machine 1 which sends the start information. If it is determined that the winning probability of bonus is changed (S42: YES), a new winning probability of bonus will be sent to the slot machine 1 which sends the start information (S43).

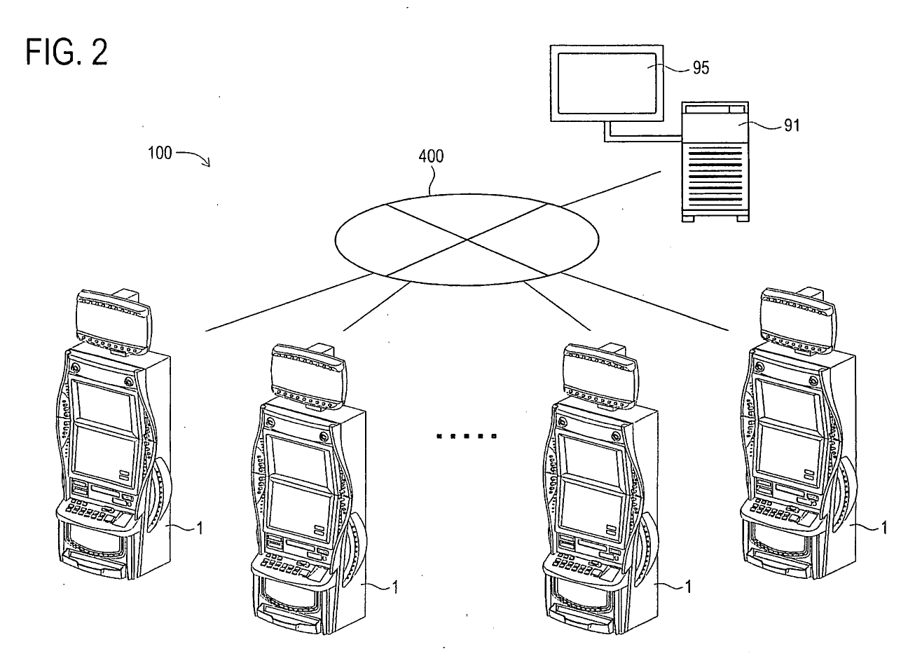

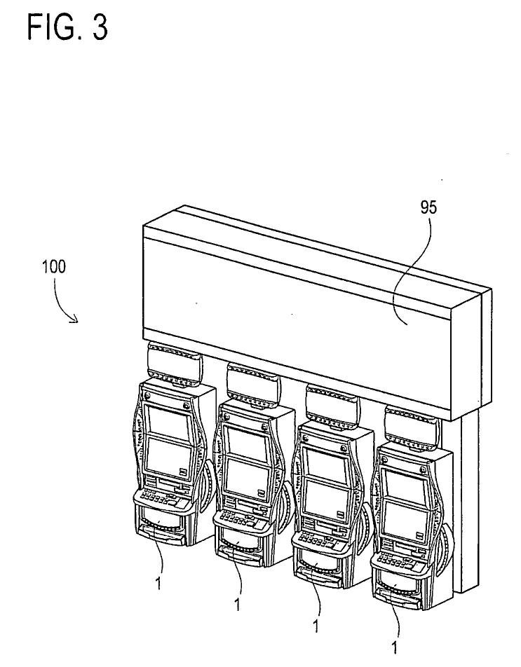

A schematic structure of a game system 100 according to the embodiment will be explained in detail with reference to the drawings. FIG. 2 is a schematic structure view of the game system 100 according to the embodiment. FIG. 3 is an external perspective view of the game system 100 according to the embodiment.

As shown in FIG. 2, the game system 100 according to the embodiment includes plural slot machines 1, a server 91 and a large-size display 95. The plural slot machines 1, a server 91 and a large-size display 95 are arranged in the game hall. Each of the slot machines 1 is connected to the server 91 via the net work 400 so as to be capable of communicating with each other. Also a large-size display 95 is connected to the server 91. Here, different types of slot machine 1 (namely slot machines with different reels, winning combinations, winning probability and the like) can be connected to the server 91.

As shown in FIG. 3, the large-size display 95 is provided above the plural slot machines 1. The large-size display 95 is a well-known large-size liquid crystal display, and displays a variety of gaming information in the game system 100 (for example, rules of the game, game result of each slot machine 1 and the like).

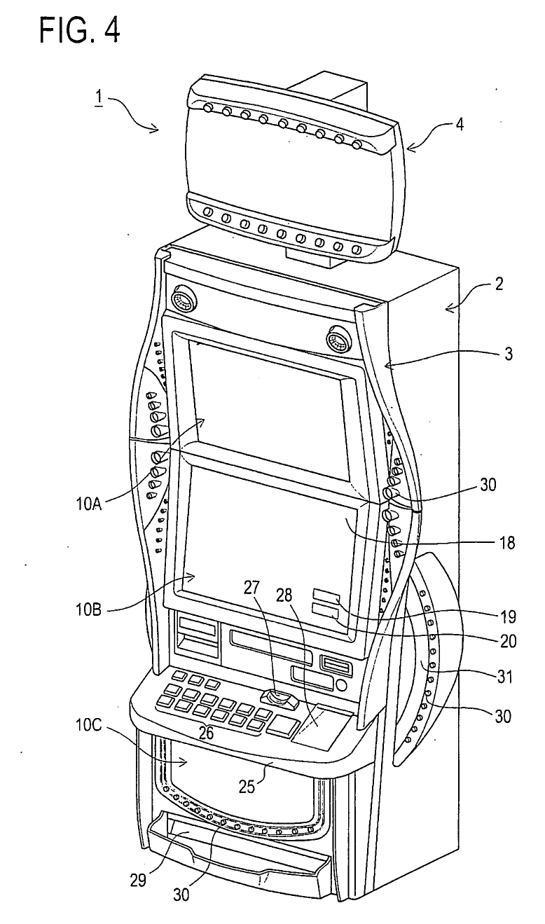

Next, the slot machine 1 which constructs the game system 100 according to the embodiment will be explained in detail with reference with the drawing. FIG. 4 is an external perspective view of the slot machine 1 according to the embodiment.

The slot machine 1 according to the embodiment is an upright type slot machine which is provided in the game hall such as the casino. The slot machine 1 includes a cabinet 2, a main door 3, and a topper effect device 4. The main door 3 is arranged in front of the cabinet 2. The topper effect 4 is arranged above the cabinet 2.

The cabinet 2 is a housing portion which houses the electric or the mechanic components for executing the predetermined gaming modes in the slot machine 1.

The slot machine 1 includes an upper display 10A, a main display 10B and a lower back panel 10C at the front side of the cabinet 2 to display various gaming information. The upper display 10A is arranged on the upper column of the cabinet 2, the main display 10B is arranged on the middle column of the cabinet 2 and the lower back panel 10C is arranged on the lower column of the cabinet 2.

The upper display 10A is constructed from the liquid crystal panel. The effect images, the payout table in the game, the game rules and the like are displayed on the upper display 10A. Also, the rank of bonus which the player wins is displayed on the upper display 10A.

The main display 10B is constructed from the liquid crystal panel. Plural reel display portions, for example, are displayed on the main display 10B. The variable display and the stop display of the symbol rows are displayed on each of the reel display portions. For example, three symbols are displayed on the reel display portion. In other words, symbols are displayed in a 3×5 matrix shape on the main display 10B. The number of the reels and the number of the display symbols on each reel display portion are variable.

A touch panel 18 is arranged on the front side of the liquid crystal panel on the main display 10B. A player may input various instructions by operating the touch panel 18. Also a payout number display portion 19 and a credit number display portion 20 are provided on the main display 10B. The display position of the payout number display portion 19 and the credit number display portion 20 are arbitrary. For example, the payout number display portion 19 and the credit number display portion 20 may be arranged on the right lower portion of the main display 10B. Also a bet amount display portion which displays the bet number may also be provided. The payout number provided to the player may be displayed on the payout number display portion 19. And the credit number which is presently owned by the player is displayed on the credit number display portion 20.

The upper display 10A and the main display 10B, for example, are constructed from the liquid crystal panel As described above, however, this invention is not limited to the liquid crystal panel. In other words, either display portion may also be the CRT display, the plasma display, the LED display, and the other well-known display device.

The lower back panel 10C is arranged on the lower column of the cabinet 2, and is constructed from a plastic panel. The drawings of the characters relating to the gaming machine, the name of the gaming machine and the like are displayed on the lower back panel 10C, and are lighted by the back lights. The lower back panel 10C may also be the liquid crystal panel, the CRT display, the plasma display, the LED display, and the other well-known display device.

Further, the main display 10B may also be configured as a hybrid type which is constructed from a mechanical reel and a transparent liquid crystal display device arranged in front of the mechanical reel. As a result, the symbols displayed on the mechanical reel may be visible via the transparent liquid crystal display device. Display windows which equals to the number of the mechanical reel are arranged on the transparent liquid crystal display device, so that the symbols displayed on the mechanical reel may be visible via the display windows. The slot machine using video reels will be mainly described in the below description, however, the invention may also be applied to the slot machines using the mechanical reels as much as possible. When mechanical reels are used, the rotation or the stop of the mechanical reels is controlled by a motor which is not shown.

Also, an operation table 25 is arranged in front of the cabinet 2. The operation table 25 is arranged to extend forward between the main display 10B and the lower back panel 10C. Plural types of operation button 26 are provided on the operation table 25. The operation buttons 26 include a BET button, a collect button, a start button, a CASHOUT button and the like. A coin insertion slot 27 and a bill insertion slot 28 are arranged on the operation table 25. The coin insertion slot 27 is used to receive coins which are the gaming media to the cabinet 2. The bill insertion slot 28 is used to receive the bills to the cabinet 2.

Further, coins, bills or electronic value (credits) which are equivalent to coins or bills are used as the gaming media in the game system 100 (including the slot machine 1) according to the embodiment. However, the gaming media applicable in one or more aspects of the invention are not limited to coins, bills or electronic value. For example, the gaming media may also be medals, tokens, electric moneys, and tickets.

A coin tray 29 is provided at the bottommost of the cabinet 2. The coin tray 29 is used to receive the coins paid out by a hopper 64. A light emitting portion 30 is provided around the cabinet 2 of the slot machine 1. The light emitting portion 30 is lighted up in a predetermined lighting mode when the player wins the game or during the event game. Further, a speaker 31 is provided on the side surface of the cabinet 2. The speaker 31 outputs sound in accordance with the progressing of the game.

The topper effect device 4 has a rectangular board shape, and is arranged almost parallel to the upper display 10A.

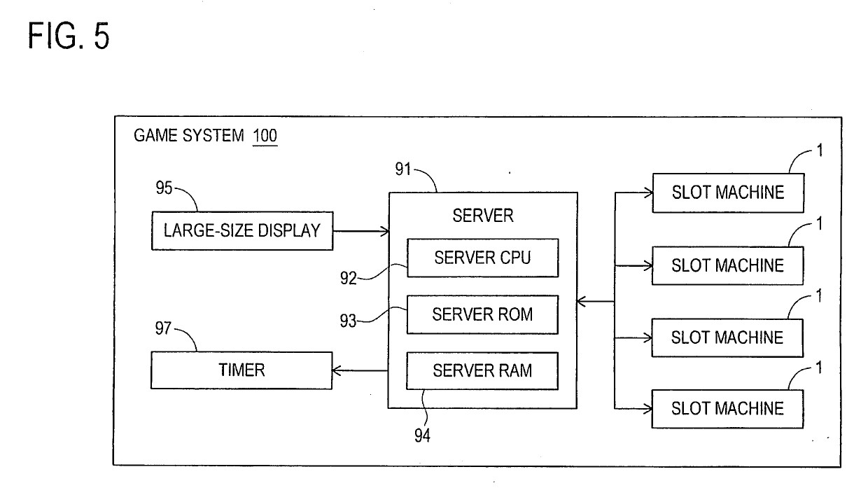

Next, the internal constitution of the game system 100 according to the embodiment will be explained in detail with reference to the drawing. FIG. 5 is a block diagram schematically showing the internal constitution of the game system 100. As shown in FIG. 5, the game system 100 includes the server 91. The server 91 controls the entirety of the game system 100.

The server 91 is constructed from a server CPU 92, a server ROM 93, and a server RAM 94. The server ROM 93 stores necessary control programs for controlling the entirety of the game system 100 and the data tables. For example, the program for the server base process to be described later is stored. The server CPU 92 executes the various control programs stored in the server ROM 93.

The server RAM 94 temporarily stores the calculation results and the like when the various control programs are executed by the server CPU 92. A first probability table, a second probability table, and a server table are stored in the server RAM 94.

Plural slot machines 1 are connected to the sever 91. The server 91 sends and receives various data with the plural slot machines 1.

The large-size display 95 is connected to the server 91. The display content of the large-size display 95 is controlled by the server 91.

A timer 97 is connected to the sever 91. The server 91 obtains the current time data by referring to the timer 97.

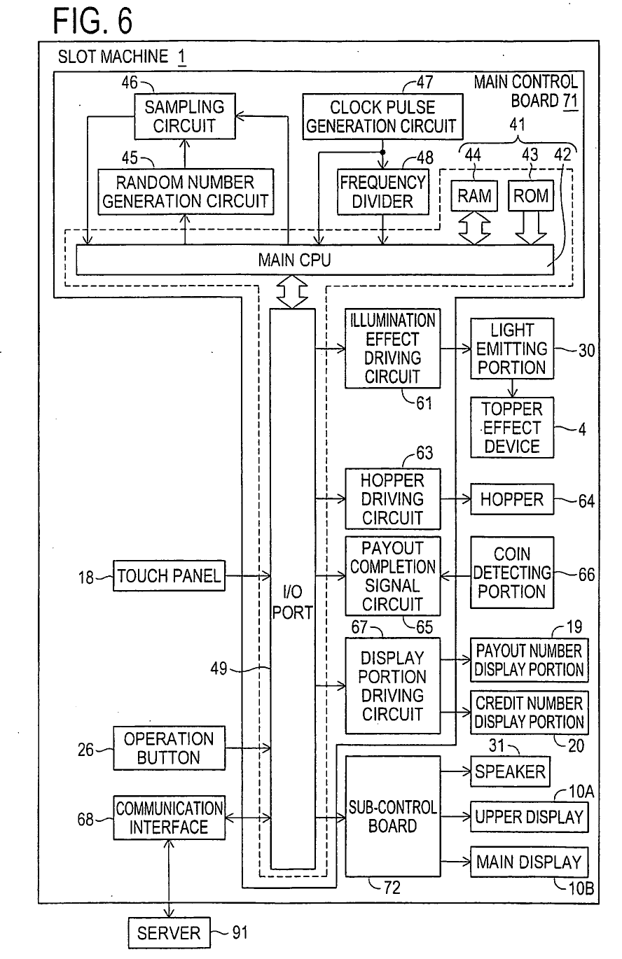

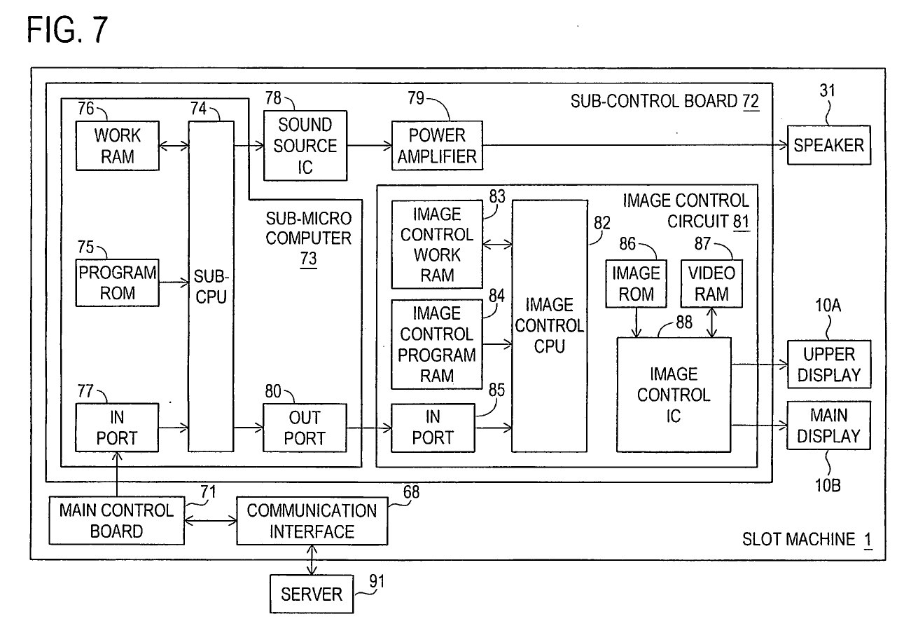

Next, the internal constitution of the slot machine 1 according to the embodiment will be explained in detail with reference to the drawings. FIG. 6 and FIG. 7 are block diagrams showing the internal constitution of the slot machine 1.

As shown in FIG. 6, the slot machine 1 includes plural constitution elements around the main control board 71.

A controller 41 includes a main CPU 42, a ROM 43, a RAM 44. The main CPU 42 inputs or outputs signals with other constitution elements via I/O port 49, and executes the programs stored in the ROM 43. The main CPU 42 serves as a control center of the slot machine 1. The RAM 44 stores temporarily the data and the programs when the main CPU 42 runs. For example, the RAM 44 temporarily stores the random number value sampled by a sampling circuit 46 to be described later. And the identification number (“ID”) of the slot machine 1 is stored in the ROM 43 or the RAM 44. The ROM 43 stores the programs executed by the main CPU 42 and the permanent data.

The main control board 71 includes a random number generation circuit 45, a sampling circuit 46, a clock pulse generation circuit 47 and a frequency divider 48.

The random number generation circuit 45 operates based on the instruction of the main CPU 42, and generates a predetermined range of random numbers. The sampling circuit 46 extracts an arbitrary random number from the random numbers generated by the random number generation circuit 45 based on the instruction of the main CPU 42. The sampling circuit 46 input the extracted random number to the main CPU 42. The clock pulse generation circuit 47 generates a basic clock to run the main CPU 42. The frequency divider 48 divides the basic clock in a predetermined frequency, and inputs the divided signals to the main CPU 42.

The touch panel 18 is connected to the main control board 71. The touch panel 18 may specify the coordinate position of the part to which the player touches. The touch panel 18 may determine the portion to which the player touches based on the specified coordinate position information, and determines the direction to which the touched place moves. The touch panel 18 inputs the signal corresponding to the determination result via the I/O port 49 to the main CPU 42.

The operation button 26 is connected to the main control board 71. As described above, the operation button 26 includes the start button, the collect button, the BET button and the like to instruct the execution of the game. When each button included in the operation buttons 26 is pressed, the operation signal is input to the main CPU 42 via the I/O port 49.

A communication interface 68 is connected to the main control board 71. The communication interface 68 is used to receive or send various data with the sever 91.

The main control board 71 also includes an illumination effect driving circuit 61, a hopper driving circuit 63, a payout completion signal circuit 65 and a display portion driving circuit 67.

The illumination effect driving circuit 61 outputs effect signals to the above-mentioned light emitting portion 30 and the topper effect device 4. And the topper effect device 4 is serially connected to the illumination effect driving circuit 61 through light emitting portions 30. When the effect signal is input, the light emitting portions 30 and the topper effect device 4 emit light in a predetermined light emitting mode. As a result, the slot machine 1 executes light emitting effect in accordance with the progressing of the game.

The hopper driving circuit 63 drives the hopper 64 based on the control of the main CPU 42. The hopper 64 executes the payout of coins, and thereby, coins are paid out to the coin tray 29. The display portion driving circuit 67 executes the display control of various display portions such as the payout number display portion 19, the credit number display portion 20 and the like.

A coin detecting portion 66 is connected to the payout completion signal circuit 65. The coin detecting portion 66 calculates the number of the coins paid out by the hopper 64. The coin detecting portion 66 inputs the data of the number of coins which is calculated to the payout completion signal circuit 65. The payout completion signal circuit 65 determines whether or not the predetermined number of coins is paid out based on the data of the number of coins input by the coin detecting portion 66. When the coins with a predetermined number are all paid out, the signal indicating the completion of the coins is input to the main CPU 42 by the payout completion signal circuit 65.

A sub-control board 72 is connected to the main control board 71. The sub-control board 72 is formed on a circuit board different from that of the main control board 71. The display control of the upper display 10A, the main display 10B and the output control of sound by the speaker 31 are executed by the sub-control board 72, based on the commands input from the main control board 71.

As shown in FIG. 7, the sub-control board 72 includes a microcomputer 73 (abbreviated as “sub-microcomputer” hereinafter) as a main constitution element. The sub-microcomputer 73 includes a sub-CPU 74, a program ROM 75, a work RAM 76, an IN port 77 and an OUT port 80. The sub-CPU 74 executes the control operations based on the control orders (commands) sent from the main control board 71. The program ROM 75 stores the control programs executed by the sub-CPU 74. The work RAM 76 is configured as a temporary storing device when the above control programs are executed by the sub-CPU 74.

The sub-control board 72 executes the random number sampling on the running program of the sub-CPU 74. As a result, the sub-control board 72 may execute the same processes as the processes executed by the clock pulse generation circuit 47, the frequency divider 48, the random number generation circuit 45, and the sampling circuit 46 in the main control board 71.

The sub-control board 72 includes a sound source IC 78, a power amplifier 79 and an image control circuit 81. The sound source IC 78 controls the sound output from the speaker 31. The power amplifier 79 is used as an amplifier for the output of the sound. And the image control circuit 81 is running as the display control device of the upper display 10A and the main display 10B.

The image control circuit 81 includes an image control CPU 82, an image control work RAM 83, an image control program ROM 84, an image ROM 86, a video RAM 87 and an image control IC 88. The image control CPU 82 determines the images displayed on the upper display 10A and the main display 10B based on the parameters set by the sub-microcomputer 73 and the image control programs.

The image control programs regarding to the display of the upper display 10A and the main display 10B and a variety of the selection tables are stored in the image control program ROM 84. The image control work RAM 83 serves as a temporary storing device when the image control programs are executed by the image control CPU 82. IN port 85 is connected to the OUT port 80. Images corresponding to the content determined by the image control CPU 82 are formed by the image control IC 88, and are output to the upper display 10A and the main display 10B. The dot data used to form images are stored in the image ROM 86. The video RAM 87 serves as a temporary storing device when the images are formed by the image control IC 88.

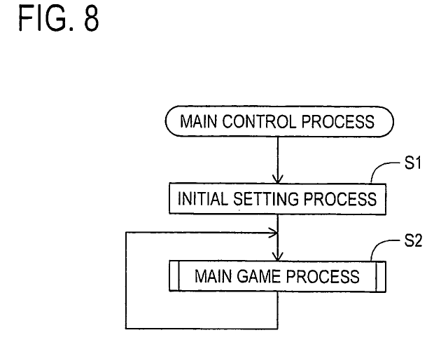

Next, the main control process executed in slot machine 1 according to the embodiment will be explained with reference to the drawing. FIG. 8 is a flowchart of the main control process. The programs for executing the main control process are stored in the ROM 43 of the slot machine 1, and are executed by the main CPU 42.

When the power switch is ON (the power is turned ON), the main control board 71 and the sub-control board 72 are activated respectively, the controller 41 executes the initial setting process of S1. In the initial setting process S1, the main CPU 42 executes the BIOS stored in the ROM 43, and extracts the compressed data incorporated in the BIOS to the RAM 44. And once the BIOS extracted in the RAM 44 is executed, diagnosis of the variety of peripheral devices and initialization are executed by the main CPU 42. Further, the CPU42 writes the game programs from the ROM 43 to the RAM 44. And also the CPU 42 executes the certification process to each program during the execution of the initial setting process.

In S2, the game program and the like are read out from the RAM 44 in sequence and are executed so as to progress the main game process. The game in the slot machine 1 according to the embodiment is progressed by the execution of the main game process. And the main game process is repeated to be executed during the power of the slot machine 1 is supplied. The detail of the main game process will be described later.

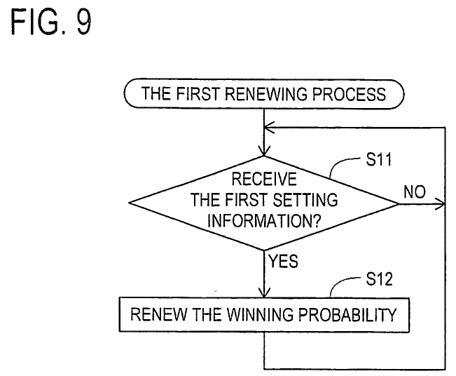

Next, a first renewing process executed in the slot machine 1 of the embodiment will be described in detail with reference to the drawing. The first renewing process is executed in parallel with the above-mentioned main game process. FIG. 9 is a flowchart of the first renewing process. The programs to execute the first renewing process are stored in the ROM 43 of the slot machine 1 and are executed by the main CPU 42.

In S11, it is determined whether or not the first setting information is received from the server 91. Here, the first setting information includes a new winning probability of bonus. If it is determined that the first setting information is not received from the server 91 (S11: NO), the game returns to S11. On the other hand, if it is determined that the first setting information is received from the server 91 (S11: YES), the game proceeds to S12.

In S12, the winning probability stored in the RAM 44 is renewed to the winning probability included in the received first setting information. That is, the winning probability stored in the RAM 44 is updated. The winning probability stored in the RAM 44 is referred by the main game process to be described later.

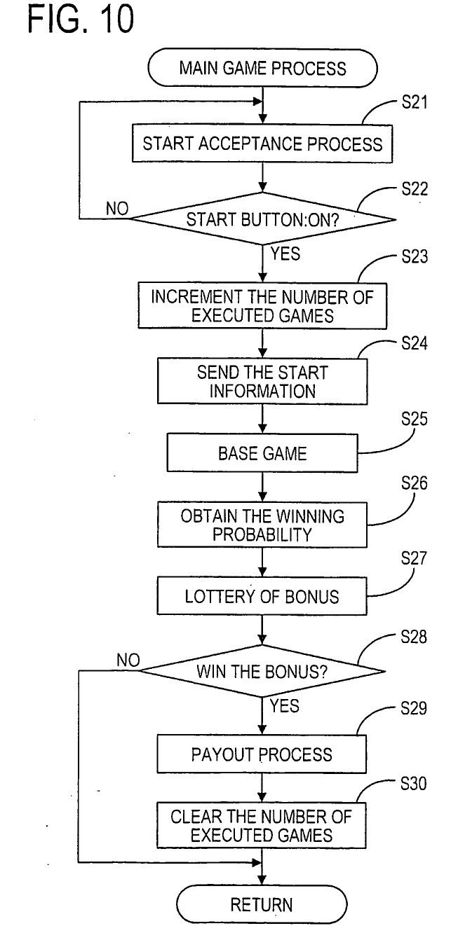

Next, the main game process will be described in detail with reference to the drawing. FIG. 10 is a flowchart of the main game process.

In S21, the start acceptance process is executed. In the start acceptance process, after the predetermined initial setting is executed, the setting of the bet number and the like are executed. And the input of coins is executed by the player from the coin insertion slot 27. The bet operation using the operation button 26 is also executed. The number of the coins inserted from the coin insertion slot 27 or the bet operation using the operation button 26 is detected respectively.

In S22, it is determined whether or not the start button is operated. That is, it is determined whether or not the start button is ON. The determination whether the start button is operated is executed based on whether or not the input signal is received from the start switch.

If it is determined that the start button is not operated (S22: NO), the game returns to the start acceptance process. The operation such as correction of the bet number is possible at this time. On the other hand, if it is determined that the start button is operated (S22: YES), the bet number which is set is deducted from the credits owned by the player, and the subtraction result is stored in the RAM 44 as the betting information. And then, the game proceeds to S23.

In S23, the number of executed games is incremented. The number of executed games is stored in the RAM 44.

In S24, the start information is sent to the server 91. The start information includes the number of executed games and the ID of the slot machine 1. And, the start information is sent each time the start button is pressed (in other words, each time the base game is executed). Accordingly, the number of executed games included in the sent start information is added by “1” each time the start information is sent.

For example, when the start information with “number of executed games: 399” is sent by the operation of the start button at this time, in the next start button operation, the start information with “number of executed games: 400” will be sent.

In S25, the base game is progressed. In the base game, for example, the symbol rows are variably displayed on the symbol display portion, and then the symbol rows are stopped and displayed. Awards are provided based on the symbol combination of the symbols stopped and displayed. As the base game, various well-know games may be executed. And, a predetermined award may be provided based on the game result. And then the game proceeds to S26.

In S26, the winning probability is obtained. At this time, the RAM 44 is referred.

In S27, the lottery of bonus is conducted based on the obtained winning probability. That is, it is determined whether or not the bonus is won based on the obtained winning probability.

In S28, it is determined whether or not the bonus is won. If it is determined that the bonus is not won (S28: NO), the main game process is terminated. If it is determined that the bonus is won (S28: YES), the game proceeds to S29.

In S29, the payout process is executed. In the payout process, a predetermined number of gaming medium is paid out. Also the payout number of the gaming medium may be set appropriately.

In S30, the number of executed games stored in the RAM 44 is cleared.

Next, the server base process executed in the server 91 will be described. FIG. 1 is a flowchart of the server base process. The programs to execute the server base process are stored in the server ROM 93 of the server 91, and are executed by the server CPU 92.

In S41, it is determined whether or not the start information is received from any of the slot machines 1. If it is determined that the start information is not received from any of the slot machines 1 (S41: NO), the game returns to S41. In other words, the process will wait at S41 until the start information is received from the any of the slot machines 1.

On the other hand, if it is determined that the start information is received from any of the slot machines 1 (S41: YES), the game proceeds to S42.

In S42, it is determined whether or not the winning probability of bonus in the above slot machine (namely the slot machine 1 which sends the start information in S41) is changed.

The determination in S42 will be described below.

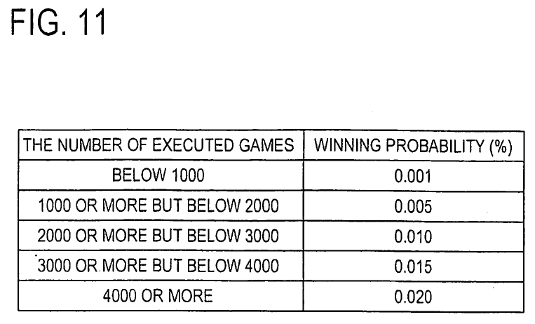

In the determination of S42, the first probability table is used. FIG. 11 shows one example of the first probability table.

In FIG. 11, it shows that when the number of executed games is below 1000, the winning probability of bonus is 0.001%.

It shows that when the number of executed games is 1000 or more but below 2000, the winning probability of bonus is 0.005%.

It shows that when the number of executed games is 2000 or more but below 3000, the winning probability of bonus is 0.010%.

It shows that when the number of executed games is 3000 or more but below 4000, the winning probability of bonus is 0.015%.

It shows that when the number of executed games is 4000 or more, the winning probability of bonus is 0.020%.

As shown in FIG. 11, the winning probability of bonus is set to be higher when the number of executed games is larger. That is, as the number of the executed games is larger, as the winning probability of the bonus is higher. Further, the corresponding relationship between the number of executed games and the winning probability of bonus shown in FIG. 11 is only one of the examples.

Here, in the slot machine 1, bonus may mean that to obtain predetermined amount of gaming media by extracting a random number value in a predetermined winning range (for example, 0 to 9) by lottery from a predetermined random number range (for example, 0 to 99999), to obtain predetermined amount of gaming medium by displaying a predetermined symbol combination is displayed on the main display 10B, or the like. The winning probability of the bonus can be changed by changing the winning range or by changing a probability of appearance of the predetermined symbol combination.

For example, if the number of executed games included in the received start information is 400, the determination in S42 is “NO” because the winning probability of bonus is still 0.001%. (In other words, when the number of executed games are 399 and 400, the winning probability of bonus are both “0.001%”.)

Also, for example, when the number of executed games included in the received start information is 1400, the determination in S42 is “NO” because the winning probability of bonus is still 0.005%. (In other words, when the number of executed games are 1399 and 1400, the winning probability of bonus are both “0.005%”.)

And, for example, when the number of executed games included in the received start information is 2000, the winning probability of bonus becomes 0.010%. In other words, the winning probability of bonus is changed from “0.005%” (which is the winning probability of bonus at the number of executed games of 1999) to “0.010%”. Thereby, the determination in S42 is “YES”.

In general, when the number of executed games included in the received start information is “n”, and the number “n” is equal to the number “N” stored in the first probability table (the attribution: the number of executed games), the determination in S42 becomes “YES”.

Accordingly, in the first probability table shown in FIG. 11, when the number of executed games included in the received start information becomes any of 1000, 2000, 3000 and 4000, the determination in S42 becomes “YES”.

Here, the description will be returned to FIG. 1. In S42, if it is determined that the winning probability of bonus is not changed (S42: NO), the game returns to S41. On the other hand, if it is determined that the winning probability of bonus is changed (S42: YES), the game proceeds to S43.

In S43, the first setting information is sent to the slot machine 1 which sends the start information in S41 based on the first probability table. New winning probability is included in the first setting information.

In above FIG. 11, for example, when the start information including “the number of executed games: 2000” is received from the slot machine 1, the first setting information with “winning probability of bonus: 0.010%” is sent to the slot machine 1. The winning probability of bonus is renewed by the slot machine 1 which receives the first setting information.

According to the first embodiment as described above, when the start button is pressed, the slot machine 1 sends the start information to the server 91. When the server 91 receives the start information from any of the slot machines 1, it is determined whether or not the winning probability of bonus is changed in the slot machine 1 which sends the start information by referring to the first probability table. Here, in the first probability table, the number of executed games corresponds to the winning probability of bonus. If it is determined that the winning probability of bonus is changed, a new winning probability of bonus is determined by referring to the first probability table, and the first setting information including the new winning probability of bonus will be sent to the slot machine 1 which sends the start information. If the slot machine 1 receives the first setting information, the winning probability of bonus is renewed based on the first setting information. And, lottery of bonus will be executed based on the renewed winning probability of bonus. Also, if the bonus is won, a predetermined number of gaming medium is paid out.

As a result, the entertainment character of the game is enhanced, and the game may attract more players. Also, since the winning probability is set to be higher while the difference value is larger, therefore, the gaming time at each slot machine may be lengthened.

### Second Embodiment

Next, the second embodiment embodying one or more aspects of the invention is described with reference to the drawings. Since the main control process executed in the slot machine 1 is the same as that executed in the first embodiment, description thereof will be omitted here.

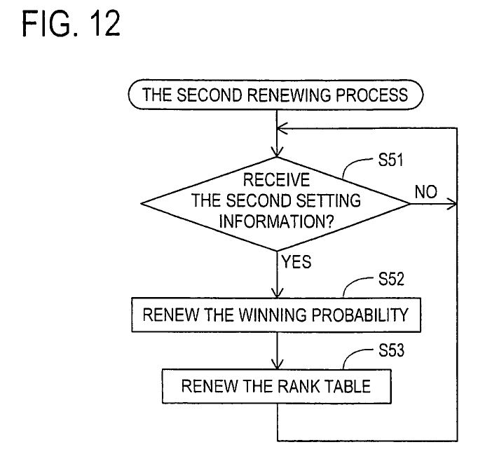

First, the second renewing process executed in the slot machine according to the embodiment will be described with reference to the drawing. The second renewing process is repeated to be executed in parallel with the main control process. FIG. 12 is a flowchart of the second renewing process. The programs for executing the second renewing process are stored in the ROM 43 provided in the slot machine 1, and are executed by the main CPU 42.

In S51, it is determined whether or not the second setting information is received from the server 91. The second setting information includes a new winning probability of bonus and a new rank table. The detail of the rank table will be described later.

If it is determined that the second setting information is not received from the server 91(S51: NO), the game returns to S51. On the other hand, if it is determined that the second setting information is received from the server 91 (S51: YES), the game proceeds to S52.

In S52, the winning probability of bonus stored in the RAM 44 is renewed to the winning probability of bonus included in the received second setting information. The winning probability of bonus stored in the RAM 44 is referred by the main game process to be described later.

In S53, the rank table stored in the RAM 44 is renewed to a rank table included in the received second setting information. And then, the game returns to S51.

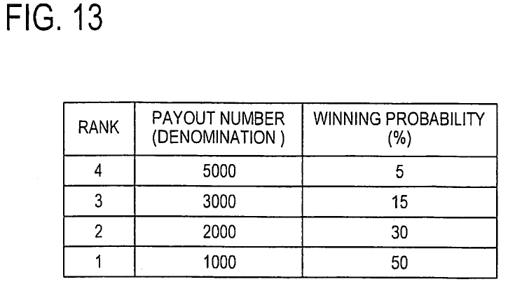

Next, the rank table will be described. FIG. 13 is one of the examples showing the rank table. In this embodiment, bonus has ranks. For example, bonus of rank 1, bonus of rank 2, bonus of rank 3 and bonus of rank 4 are included in the plural bonuses. That is, the ranks include rank 1, rank 2, rank 3, and rank 4.

Here, the payout number of the bonus of rank 4 is larger than the payout number of the bonus of rank 3. The payout number of the bonus of rank 3 is larger than the number of the bonus of rank 2. The payout number of the bonus of rank 2 is larger than the payout number of the bonus of rank 1. In other words, the higher the rank of bonus is, the more the payout number is. That is, the rank is larger, the payout number is larger.

As shown in FIG. 13, in the rank table, to each rank of bonus, the payout number and the winning probability correspond to the winning probability of bonus.

FIG. 13 shows that the bonus of rank 4 is defined as “payout number is 5000 denominations” and “winning probability is 5%”.

It shows that the bonus of rank 3 is defined as “payout number is 3000 denominations” and “winning probability is 15%”.

It shows that the bonus of rank 2 is defined as “payout number is 2000 denominations” and “winning probability is 30%”.

It shows that the bonus of rank 1 is defined as “payout number is 1000 denominations” and “winning probability is 50%”.

The amount of one denomination may be determined appropriately. For example, it may be defined as “1 denomination=1$” or “1denomination=25¢”.

The rank table may be referred in the main game process to be described later, at the time when the rank of bonus which is won is determined or at the time when the payout number of the gaming medium is determined.

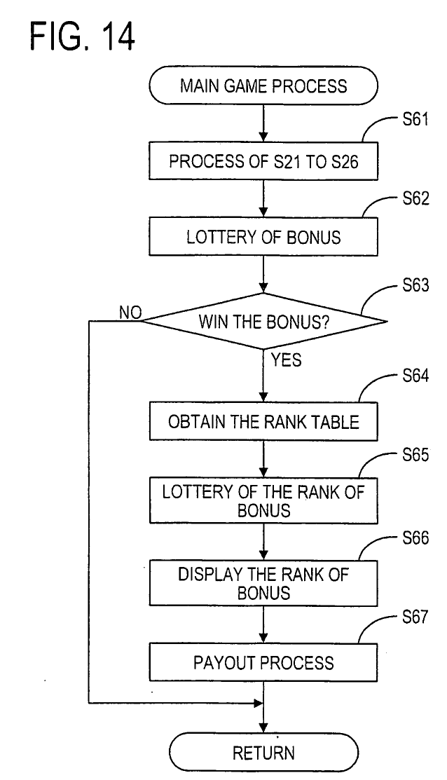

Next, the main game process in the second embodiment will be described with reference to the drawing. FIG. 14 is a flowchart of the main game process.

In S61, the above-described processes S21 to S26 (see FIG. 10) are executed.

In S62, the lottery of bonus is executed based on the winning probability which is obtained. That is, it is determined whether or not the bonus is won based on the obtained winning probability.

In S63, it is determined whether or not the bonus is won. If it is determined that the bonus is not won (S63: NO), the main game process is terminated. On the other hand, if it is determined that the bonus is won (S63: YES), the game proceeds to S64.

In S64, the rank table is obtained. At this time, the RAM 44 is referred.

In S65, a lottery is held to the rank of bonus based on the obtained rank table. That is, the rank of the bonus to be provided is determined based on the obtained rank table.

In S66, the determined rank of bonus is displayed on the upper display 10A. And the display layout in the upper display 10A may be set appropriately.

In S67, the gaming media equal to the payout number which corresponds to the determined rank are paid out based on the rank table.

For example, when the rank table shown in FIG. 13 is used, if the bonus of rank 3 is won, 3000 denominations will be paid out. That is, if it is determined that the rank is “3”, the “3000” of gaming media will be provided.

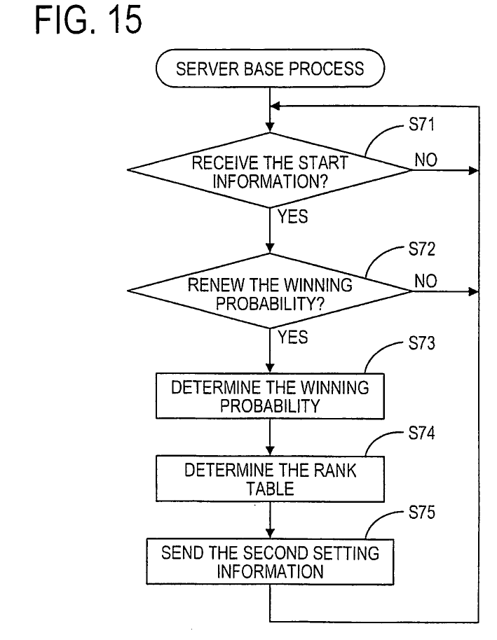

Next, the server base process in the second embodiment will be described with reference to the drawing. FIG. 15 is a flowchart of the server base process.

In S71, it is determined whether or not the start information is received from any of the slot machines 1. If it is determined that the start information is not received from any of the slot machines 1 (S71: NO), the game returns to S71. In other words, the game will wait at S71 until the start information is received from the any of the slot machines 1.

On the other hand, if it is determined that the start information is received from the any of the slot machines 1 (S71: YES), the game proceeds to S72.

In S72, it is determined whether or not the winning probability of bonus in the slot machine 1 (the slot machine 1 which sends the start information in S71) is changed.

The determination in S72 will be described below.

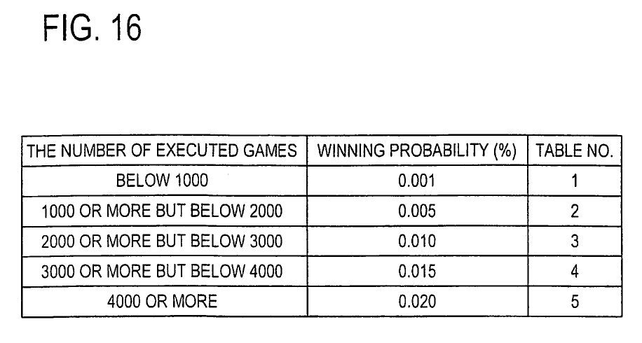

The second probability table is used in the determination of S72. FIG. 16 shows one of the examples of the second probability table. The second probability table is obtained by adding “attribution: table number” to the first probability table. The detail of the table number will be explained later.

The determination in S72 is executed in a same way as the determination in the above first embodiment (S42 in FIG. 1) by using “attribution: the number of executed games”.

Description will be returned to FIG. 15. In S72, if it is determined that the winning probability of bonus is not changed in the slot machine 1 (S72: NO), the game returns to S71. On the other hand, if it is determined that the winning probability of bonus is changed in the slot machine 1 (S72: YES), the game proceeds to S73.

In S73, a new winning probability of bonus is determined in the slot machine 1 which sends the start information in S71 based on the second probability table.

In S74, a new rank table is determined in the slot machine 1 which sends the start information in S71 based on the server table.

The determination of the rank table will be described below.

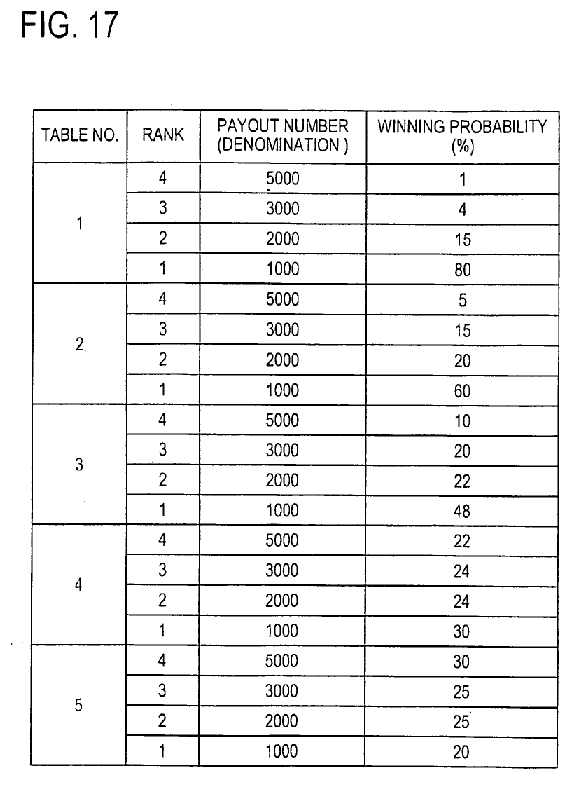

The server table is used in the determination of the rank table. FIG. 17 shows one of the examples of the server table.

As shown in FIG. 17, the server table is constructed from five rank tables which are a rank table of “table No. 1”, a rank table of “table No. 2”, a rank table of “table No. 3”, a rank table of “table No. 4”, and a rank table of “table No. 5”.

Plural sets of the rank, the payout number and the winning probability of bonus are defined to each table number.

The attribution value of the table number is the same as that of the table number in the second probability table.

Accordingly, in the rank table of the “table No. 1”, the payout number and the winning probability of each rank are defined in the case that the number of executed games is below 1000.

In a same way, in the rank table of the “table No. 2”, the payout number and the winning probability of each rank are defined in the case that the number of executed games is 1000 or more but below 2000.

In the rank table of the “table No. 3”, the payout number and the winning probability of each rank are defined in the case that the number of executed games is 2000 or more but below 3000.

In the rank table of the “table No. 4”, the payout number and the winning probability of each rank are defined in the case that the number of executed games is 3000 or more but below 4000.

In the rank table of the “table No. 5”, the payout number and the winning probability of each rank are defined in the case that the number of executed games is 4000 or more.

As shown in FIG. 17, it is configured that the winning probability of bonus is set to be higher when the number of executed games is larger. That is, as the number of executed games is larger, as the winning probability of the bonus of higher rank is higher.

For example, concerning the rank 4 (higher rank), the winning probability of the bonus in the table number 1 is “1%”.

The winning probability of the bonus in the table number 2 is “5%”.

The winning probability of the bonus in the table number 3 is “10%”.

The winning probability of the bonus in the table number 4 is “22%”.

The winning probability of the bonus in the table number 5 is “30%”.

For example, when the number of executed games included in the received start information is 2000, the table number is defined as “3” by referring to the second probability table. And, the rank table corresponding to the “table No. 3” becomes a new rank table by referring to the server table.

Further, the corresponding relationship among the “table number”, the “rank”, the “payout number”, and the “winning probability of bonus” shown in FIG. 17 is only one of the examples.

Here, description will be returned to FIG. 15. In S75, the second setting information is sent to the slot machine 1 which sends the start information in S71. The winning probability of bonus determined in S73 and the rank table determined in S74 are included in the second setting information. The slot machine 1 which receives the second setting information renews the winning probability of bonus and the rank table.

According to the second embodiment as described above, when the start button is pressed, the slot machine 1 sends the start information to the server 91. When the server 91 receives the start information from any of the slot machines 1, it is determined whether or not the winning probability of bonus is changed in the slot machine 1 which sends the start information by referring to the second probability table. Here, in the second probability table, the number of executed games corresponds to the winning probability of bonus. If it is determined that the winning probability of bonus is changed, a new winning probability of bonus is determined by referring to the second probability table, and a new rank table is determined by referring to the second probability table and the server table. Here, the server table is constructed from plural rank tables. And, the second setting information including the new winning probability of bonus and the new rank table will be sent to the slot machine 1 which sends the start information. When the slot machine 1 receives the second setting information, the winning probability of bonus and the rank table are renewed based on the second setting information. And, lottery of bonus will be held based on the renewed winning probability of bonus. Also, when the bonus is won, the rank of bonus is determined based on the renewed rank table, and a predetermined number of gaming media corresponding to the determined rank is paid out.

As a result, the entertainment character of the game is enhanced, and the game may attract more players. Also, the winning probability is set to be higher while the number of executed games is larger, and the winning probability of bonus becomes higher while the rank of bonus is higher, therefore, the gaming time at each slot machine may be lengthened.

Here, aspects of the invention are not limited to the above embodiment and various changes and modification can be done within the scope of the present invention.

For example, one or more aspects of the invention may also be applied to the game system with link progressive bonus. In this case, the invention may be configured to accumulatively adding up a part of the bet number in each slot machine, and the accumulatively added number may be paid out to the slot machine which wins the bonus.

When a predetermined condition is satisfied during the main game process, the free game may be executed.

One or more aspects of the invention may be applied as a gaming method to execute the above process. Further, one or more aspects of the invention may be applied to the program for executing the gaming method by computer, or may be applied as the record medium (tangible medium) in which the program is stored.

What is claimed is:

1. A game system comprising:
gaming machines; and
a server connected to the gaming machines;
wherein
the server is programmed to:
(a) obtain a number of executed games from one of the gaming machines,
(b) determine information related to a bonus in the one of the gaming machines based on the received number, and
(c) send the determined information to the one of the gaming machines,
the gaming machine is programmed to:
(d) determine whether or not the bonus is won based on the received information,
(e) provide a predetermined number of gaming medium when the bonus is won, and
(f) clear the number of the executed games when the bonus is won.

2. The game system according to claim 1, wherein the information related to the bonus is a winning probability of the bonus.

3. The game system according to claim 2, wherein as the number of executed games is larger, the winning probability of the bonus is higher.

4. The game system according to claim 1,
wherein the information related to the bonus includes a winning probability of the bonus and winning probabilities of ranks of the bonus, and
wherein the gaming machine is programmed to:
(g) determine whether or not the bonus is won based on the winning probability, and
(h) determine a winning rank of the bonus based on the winning probabilities of the ranks,
(i) provide an outcome corresponding to the determined winning rank.

5. The game system according to claim 4, wherein as the number of executed games is larger, as the winning probability of one of the ranks is higher, the one of the ranks being higher than other ranks.

6. A server connected to gaming machines, wherein the server is programmed to:
(a) obtain a number of executed games from one of the gaming machines,
(b) determine information related to a bonus in the one of the gaming machines based on the received number, and
(c) send the determined information to the one of the gaming machines,

7. The server according to claim 6, wherein the information related to the bonus is a winning probability of the bonus.

8. The server according to claim 7, wherein as the number of executed games is larger, the winning probability of the bonus is higher.

9. The sever according to claim 6, wherein the information related to the bonus includes a winning probability of the bonus and winning probabilities of ranks of the bonus.

10. The server according to claim 9, wherein as the number of executed games is larger, as the winning probability of one of the ranks is higher, the one of the ranks being higher than other ranks.

11. A gaming machine connected to a server, wherein the gaming machine is programmed to:
(a) increment a number of executed games each time the game being executed,
(b) send the incremented number of executed games to the server,
(c) receive information related to a bonus,
(d) determine whether or not the bonus is won based on the received information,
(e) provide a predetermined number of gaming medium when the bonus is won, and
(f) clear the number of the executed games when the bonus is won.

12. The gaming machine according to claim 11, wherein the information related to the bonus is a winning probability of the bonus.

13. The gaming machine according to claim 11,
wherein the information related to the bonus includes a winning probability of the bonus and winning probabilities of ranks of the bonus, and
wherein the gaming machine is programmed to:
(g) determine whether or not the bonus is won based on the winning probability,
(h) determine a winning rank of the bonus based on the winning probabilities of the ranks, and
(i) provide an outcome corresponding to the determined winning rank.
